(19) United States
(12) Patent Application Publication
(10) Pub. No.: US 2012/0139998 A1
(43) Pub. Date: Jun. 7, 2012

(54) LIQUID EJECTION HEAD AND METHOD OF PRODUCING THE SAME

(75) Inventors: Mitsuru Chida, Yokohama-shi (JP); Yoshinori Tagawa, Yokohama-shi (JP); Hiroyuki Murayama, Kawasaki-shi (JP); Makoto Watanabe, Yokohama-shi (JP); Masataka Nagai, Yokohama-shi (JP)

(73) Assignee: CANON KABUSHIKI KAISHA, Tokyo (JP)

(21) Appl. No.: 13/292,532

(22) Filed: Nov. 9, 2011

(30) Foreign Application Priority Data
Dec. 6, 2010 (JP) 2010-271739

(51) Int. Cl. B41J 2/14

(52) U.S. Cl. 347/47

(57) ABSTRACT

A liquid ejection head including a flow path forming member which forms an ejection orifice which is opened on a front surface and which ejects a liquid, and a liquid flow path which continues to the ejection orifice; and a substrate including a liquid chamber which is opened on a back surface on an opposite side of the front surface and which includes a first slope which becomes narrower from a back surface side toward a front surface side, a liquid pathway which is opened in the first slope and connects the liquid flow path and the liquid chamber, and a first hollow portion which is provided in a bottom portion of the liquid chamber.

### BACKGROUND OF THE INVENTION

1. Field of the Invention

The present invention relates to a liquid ejection head which ejects a liquid, and a method of producing the liquid ejection head.

2. Description of the Related Art

An ink jet print method includes producing air bubbles by heat vaporization of a liquid to which an action of thermal energy is applied, and spraying liquid droplets from ejection orifices of an ink jet recording head toward a print medium by means of an expansion force caused by the growth of these air bubbles. These liquid droplets print predetermined image information such as texts or images on a print medium. The ink jet recording head used in this method generally employs the following configuration.

1. Ejection orifices which eject liquid.

2. Liquid flow paths which continue to ejection orifices.

3. Heat-accumulating layer which accumulates heat generated by ejection energy generating elements.

4. Ejection energy generating elements which are arranged in the heat-accumulating layer and generate thermal energy for spraying liquid from ejection orifices.

5. Passivation layer which protects ejection energy generating elements from liquid.

Further, it is disclosed to form a liquid chamber which continues to the above liquid flow paths and supplies a liquid to these liquid flow paths according to, for example, a method of combining pilot holes formed by, for example, anisotropic etching or YAG laser and anisotropic etching.

Further, Japanese Patent Application Laid-Open No. 2006-130742 discloses a method of forming liquid pathways of liquid flow paths and a liquid chamber by means of a plurality of penetration holes having a smaller cross-sectional area than ejection orifices.

The liquid chamber formed by crystal anisotropic etching is directly jointed to the liquid flow paths as is, and, generally, the portion having the smallest cross-sectional area of a pathway in which a liquid flows forms ejection orifices.

In recent years, the diameter of ejection orifices of an ink jet recording head tends to become smaller following improvement of printing quality, and, if there is dust mixed in an ink, there is a higher possibility that the dust is jammed in the ejection orifices. This clogging of dust causes printing failure such as failure to eject an ink.

As discussed in Japanese Patent Application Laid-Open No. 2006-130742 as a method of solving clogging of dust, a technique is disclosed which forms ink pathways of an ink chamber and ink flow paths by means of through-holes having a smaller cross-sectional area than the ejection orifices. However, with the shape discussed in Japanese Patent Application Laid-Open No. 2006-130742, the dust accumulated in the ink chamber freely moves in the ink chamber when the ink flows, and therefore there is a concern that the moving dust is jammed in the ink pathways. It is therefore an object of the present invention to provide a liquid ejection head which can prevent clogging of dust.

### SUMMARY OF THE INVENTION

The invention relates to a liquid ejection head including a flow path forming member which forms an ejection orifice which is opened on a front surface and which ejects a liquid, and a liquid flow path which continues to the ejection orifice, and a substrate including a liquid chamber which is opened on a back surface on an opposite side of the front surface and which has a first slope which becomes narrower from a back surface side toward a front surface side, a liquid pathway which is opened in the first slope and connects the liquid flow path and the liquid chamber, and a first hollow portion which is provided in a bottom portion of the liquid chamber.

Further features of the present invention will become apparent from the following description of exemplary embodiments with reference to the attached drawings.

### BRIEF DESCRIPTION OF THE DRAWINGS

FIGS. 1A, 1B and 1C are schematic sectional views and a perspective view illustrating a configuration example of the present embodiment.

FIGS. 2A, 2B and 2C, and 2AS, 2BS and 2CS are schematic sectional process views and perspective process views for describing a producing method according to the present embodiment.

FIGS. 3A, 3B and 3C, and 3AS, 3BS and 3CS are schematic perspective process views and sectional process views for describing a producing method according to the present embodiment subsequent to FIG. 2C.

FIGS. 4A, 4B, 4C and 4D, and 4AS, 4BS, 4CS and 4DS are schematic perspective process views and sectional process views for describing a producing method according to the present embodiment subsequent to FIG. 3C.

FIGS. 5A and 5B, and 5AS and 5BS are schematic perspective process views and sectional process views for describing a producing method according to the present embodiment.

FIGS. 6A and 6B, and 6AS and 6BS are schematic perspective process views and sectional process views for describing a producing method according to the present embodiment.

FIGS. 7A, 7B, 7C and 7D are schematic sectional views illustrating a shape of a first hollow portion according to the present embodiment.

### DESCRIPTION OF THE EMBODIMENTS

Preferred embodiments of the present invention will now be described in detail in accordance with the accompanying drawings.

A liquid ejection head according to the present invention includes a flow path forming member which forms ejection orifices which are opened on a front surface and which ejects a liquid, and liquid flow paths which continue to the ejection orifices. Further, the liquid ejection head has a substrate including a liquid chamber which is opened on a back surface on the opposite side of the front surface and which has first slopes which become narrower from the back surface toward the front surface; liquid pathways which are opened in the first slopes and which connect the liquid flow paths and liquid chamber; and a first hollow portion which is provided in a bottom portion of the liquid chamber. When this configuration is employed, dust is more likely to accumulate in the hollow portion provided in the bottom portion of the liquid chamber, and dust settled on the hollow portion hardly moves by a flow of a liquid such as an ink. Consequently, by employing the configuration of the present invention, it is possible to provide a liquid ejection head which can prevent clogging of dust.

Hereinafter, embodiments of the present invention will be described. In addition, the present invention is by no means limited to the following embodiments.

Further, although an ink jet recording head will be described as an application example of the present invention in the following description, the application range of the present invention is by no means limited to this, and the present invention is applicable to, for example, a liquid ejection head for producing a biochip and for use in electronic circuit printing. As a liquid ejection head, there is, for example, a color filter producing head in addition to an ink jet recording head.

### First Embodiment

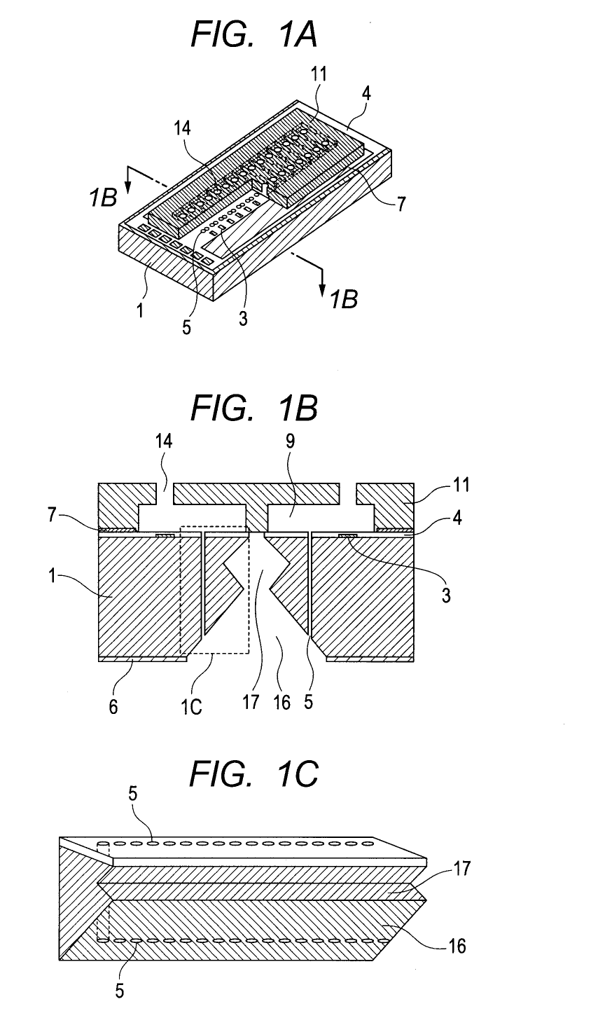

FIGS. 1A to 1C are a schematic view for describing a configuration of an ink jet recording head according to the present embodiment. FIG. 1A is a schematic perspective view of an ink jet recording head, and FIG. 1B is a schematic sectional view in a 1B-1B line of FIG. 1A. FIG. 1C is a schematic perspective view illustrating a configuration of a dotted line 1C in FIG. 1B.

The ink jet recording head illustrated in FIG. 1A to 1C have a silicon substrate 1 in which an ejection energy generating element 3 is formed and aligned in two rows at a predetermined pitch. On the silicon substrate 1, a polyamide resin layer which is an adhesion-improving layer 7 is formed. Further, a flow path forming member 11 is formed on the silicon substrate 1. The flow path forming member 11 includes an ink ejection orifice 14 which ejects an ink and an ink flow path 9 which continues to the ink ejection orifice 14. The ink ejection orifice 14 is formed above the ejection energy generating element 3. In addition, the surface on which the ink ejection orifice 14 is opened is the front surface.

The silicon substrate 1 has an ink pathway 5 which continues to the ink flow path 9, an ink chamber 16 which is opened on the back surface and supplies an ink to the ink pathway 5 and a first hollow portion 17 which is provided in the bottom portion of the ink chamber 16. The ink pathway 5 continues to the ink chamber 16 and the ink flow path 9. The first hollow portion 17 which continues to the ink chamber is formed in the bottom portion of the ink chamber 16. Further, the opening of the ink pathway 5 in the ink chamber 16 is provided closer to the back surface side than the opening of the first hollow portion 17 provided in the bottom portion of the ink chamber 16. Further, the opening of the ink pathway 5 in the ink flow path 9 is provided on the inner side of the two rows of the ejection energy generating element 3.

The ink chamber 16 is opened on the back surface, and has a first slope which becomes narrower from the back surface side toward the front surface side. The ink chamber 16 can be formed by, for example, crystal anisotropic etching of silicon. The ink pathway 5 is opened in the first slope of the ink chamber 16, and supplies an ink from the ink chamber 16 to the ink flow path 9.

The first hollow portion 17 has a second slope which becomes wider from the end of the first slope toward the front surface, and a third slope which becomes narrower from the end of the second slope toward the front surface. As illustrated in FIG. 1, the first hollow portion 17 is formed across nozzle rows. The first hollow portion 17 can be formed by providing a pilot hole on a <100> surface of the bottom portion of the ink chamber 16 formed by, for example, first crystal anisotropic etching processing, and then applying second crystal anisotropic etching processing to the <100> surface. As in the present embodiment, by forming a constricted shape at the boundary between the ink chamber 16 and first hollow portion 17, it is possible to more effectively cause stagnation of an ink when an ink flows in the first hollow portion 17 and make it difficult for dust deposited in the first hollow portion 17 to float again.

Further, the opening of the ink pathway in the ink chamber preferably has a smaller cross-sectional area than a front surface opening of the ink ejection orifice 14. Further, the ink pathway is preferably formed with a hole having a smaller cross-sectional area than the ink ejection orifice.

The ink jet recording head applies the pressure generated by the ejection energy generating element 3, to an ink (liquid) in the ink flow path 9 from the ink chamber 16 through the ink pathway 5 to eject ink liquid droplets from the ink ejection orifice 14. Further, the ink jet recording head causes the ink liquid droplets to adhere to a target recording medium.

The ink chamber 16 can be formed by crystal anisotropic etching of silicon using a silicon oxide film 6 provided on the back surface of the silicon substrate 1 as a mask.

The ink jet recording head according to the present embodiment is preferably disposed such that the ink ejection orifice 14 is oriented downward when the ink jet recording head is mounted in the device. By employing this configuration, dust is more likely to be deposited in the first hollow portion 17 due to gravity.

The ink jet recording head can be mounted in, for example, printers, copy machines, facsimiles which have communication systems, devices such as word processors which have printer units and commercial recording devices which are combined with various processing devices in a complex manner. Further, the ink jet recording head enables recording on a target recording medium such as paper, threads, fibers, leather, metal, plastic, glass, wood and ceramic. In addition, in this description, “recording” means not only applying meaningful images such as characters or figures, on a target recording medium, but also applying meaningless images such as patterns on the target recording medium.

### Second Embodiment

Hereinafter, a method of producing an ink jet recording head according to the present embodiment will be described with reference to the drawings. In addition, the present invention is by no means limited to the present embodiment, and is also applicable to other techniques which can be included in the concept of the present invention as set forth in claims.

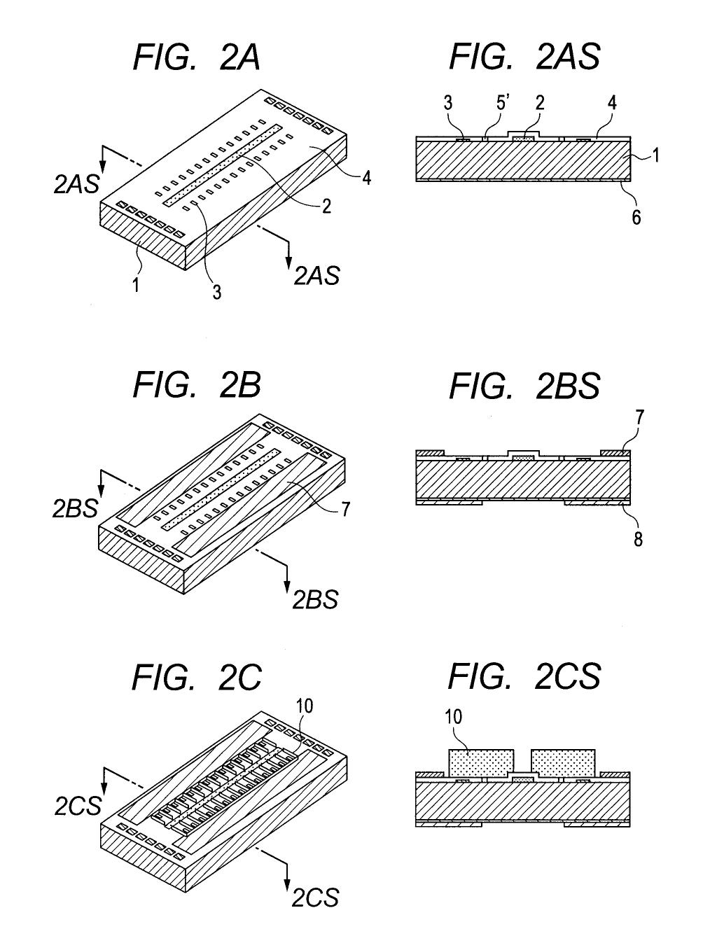

FIGS. 2A to 2C, 3A to 3C and 4A to 4D are schematic perspective views for describing an example of producing process of an ink jet recording head according to the present embodiment, and FIGS. 2AS to 2CS, 3AS to 3CS and 4AS to 4DS are schematic sectional views of these perspective views.

On a silicon substrate 1 (having, for example, a thickness of 600 to 900 μm) illustrated in FIG. 2A, a plurality of ejection energy generating elements 3 such as heat generating resistors are arranged. Further, the entire back surface of the silicon substrate 1 is covered by a silicon oxide film 6.

Further, a sacrifice layer 2 is formed on the silicon substrate 1. When the silicon substrate 1 is etched by an alkaline solution in a subsequent process, this sacrifice layer 2 plays a role of adjusting the etching dimension. The width of the sacrifice layer 2 is, for example, 80 to 150 μm. This sacrifice layer 2 can be etched by an alkaline solution. The material of the sacrifice layer 2 includes, for example, polysilicon, or aluminum, aluminum silicon, aluminum copper or aluminum silicon copper which has high etching rate.

Further, on the silicon substrate 1 and sacrifice layer 2, an etching stop layer 4 is provided. The etching stop layer 4 needs to stop progress of etching using an alkaline solution after the sacrifice layer 2 is exposed upon anisotropic etching in a subsequent process. For the etching stop layer 4, for example, silicon oxide or silicon nitride can be used. Further, it is preferable to use for the etching layer, for example, silicon oxide which is used as a heat-accumulating layer and positioned on the back surface side of a heater, or silicon nitride which functions as a protection film and is positioned in an upper layer of the heater.

Further, as illustrated in FIG. 2AS, the heat-accumulating layer and etching stop layer (SiN) 4 at portions (5′) corresponding to positions at which the ink pathway 5 is formed in a subsequent process are preferably removed. Thus, it is possible to easily form ink pathways.

In addition, wirings of the heater, a semiconductor element for driving this heater and the heat-accumulating layer are not illustrated.

Next, as illustrated in FIG. 2B, on the front surface side of the silicon substrate 1, that is, on the etching stop layer 4, an adhesion-improving layer 7 is formed. Further, on the back surface side of the silicon substrate 1, that is, on the silicon oxide film 6, an etching mask layer 8 is formed. The adhesion-improving layer 7 can be formed by using and performing baking treatment and patterning treatment with, for example, polyamide resin. The adhesion-improving layer 7 can be patterned by applying, exposing and developing a positive resist by, for example, spin coating to conduct dry-etching of the material of the adhesion-improving layer. The positive resist is peeled off. The etching mask layer 8 can also be formed in the same way.

Next, as illustrated in FIG. 2C, on the front surface side of the silicon substrate 1, that is, on the etching stop layer 4, a flow path pattern member 10 which serves as molds for ink flow paths is formed. The thickness of the flow path pattern member 10 is, for example, 10 to 25 μm, and can be formed by patterning the positive resist.

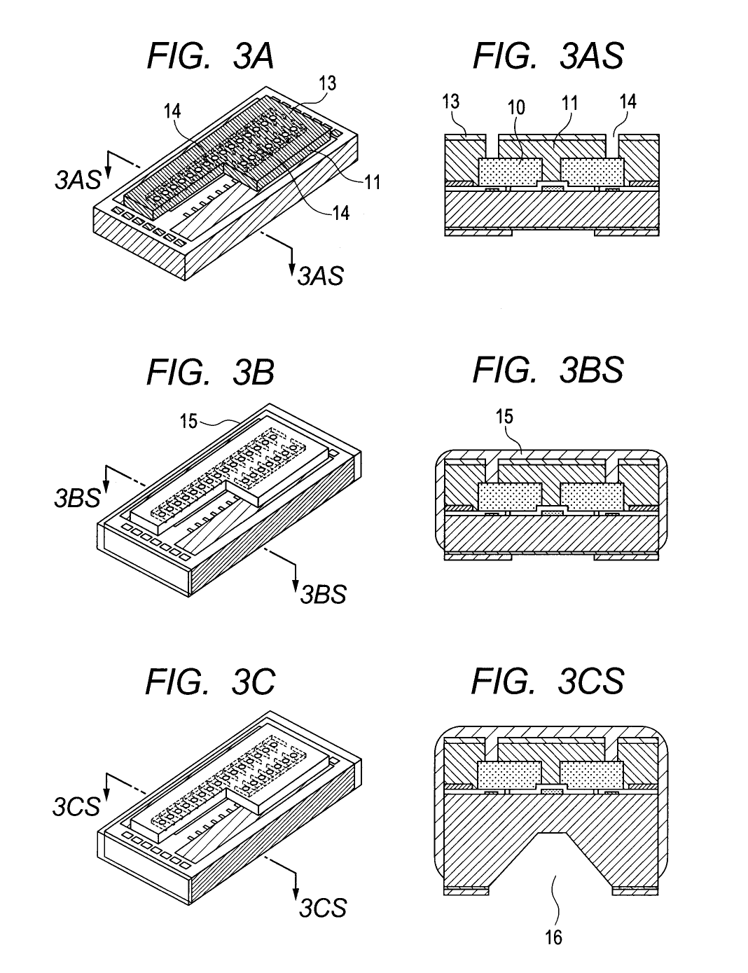

Next, as illustrated in FIG. 3A, on the adhesion-improving layer 7 and flow path pattern member 10, a flow path forming member 11 is formed. The thickness of the flow path forming member 11 is, for example, 20 to 100 μm. The flow path forming member 11 can be formed by arranging a resin material by, for example, a spin coating method. Further, on the flow path forming member 11, a water repellent material 13 can be formed by, for example, laminating a dry film. An ink ejection orifice 14 can be formed by exposure by means of ultraviolet rays or Deep UV light followed by development to pattern the flow path forming member 11. The diameter of the ink ejection orifice 14 is, for example, 10 to 30 μm.

Next, as illustrated in FIG. 3B, a protection member 15 is formed by, for example, spin coating on the front surface side and lateral surface sides of the silicon substrate 1 on which the flow path pattern member 10 and flow path forming member 11 are formed to protect the substrate.

Next, as illustrated in FIG. 3C, after a silicon surface from which etching is started is exposed, an ink chamber 16 is provided by crystal anisotropic etching. More specifically, the silicon oxide film 6 on the back surface of the silicon substrate 1 is removed first using the etching mask layer 8 as a mask. Then, the back surface of the silicon substrate 1 is etched using TMAH as an anisotropic etching solution to form the ink chamber 16 in which the <100> surface of the silicon substrate 1 is exposed. The ink chamber 16 can be formed by etching half or more of the thickness of the silicon substrate.

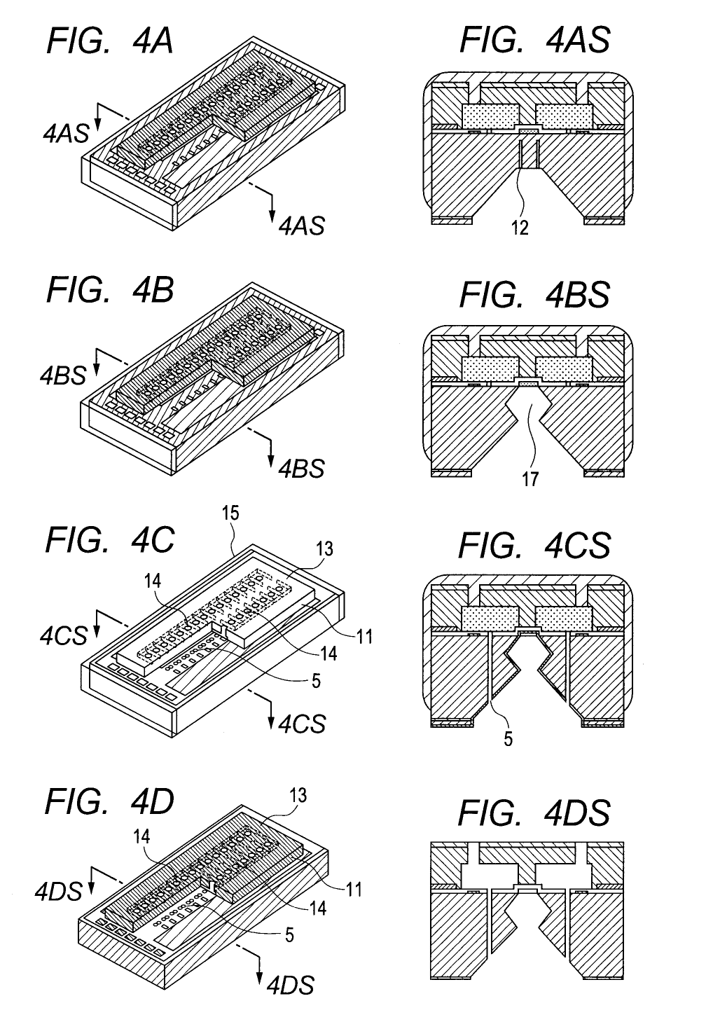

Next, as illustrated in FIG. 4A, a pilot hole 12 is formed by laser on the <100> surface exposed in the bottom portion of the ink chamber 16. The pilot hole 12 is left as a non-penetrated hole, and can be formed in two rows in parallel. For laser, laser of a fundamental wave of YAG or laser of the second or third harmonic can be used.

Further, using TMAH as an anisotropic etching solution, the etching surface is allowed to reach the interior of the sacrifice layer 2 to form the first hollow portion 17 continuing to the ink chamber 16 in the silicon substrate 1 as illustrated in FIG. 4B.

Next, as illustrated in FIG. 4C, a resist is applied on the entire back surface of the silicon substrate 1 by, for example, spray coating. Subsequently, the ink pathway 5 is formed to be opened in the first slopes of the ink chamber 16 closer to the back surface side than the first hollow portion 17. The ink pathway 5 can be formed by making a hole which reaches the flow path pattern member 10 using, for example, high-power laser. Further, the ink pathway 5 can be formed by making a hole in the silicon substrate 1 up to a position close to the flow path pattern member 10, and further allowing the hole to penetrate the silicon substrate 1 to its front surface by, for example, dry etching. The diameter of the ink pathway 5 is, for example, 10 to 50 μm. For laser, laser of a fundamental wave of YAG or laser of the second or third harmonic can be used.

Next, as illustrated in FIG. 4D, the resist provided on the back surface of the silicon substrate 1 is peeled off. Subsequently, the etching mask layer 8 is removed by dry etching. Further, the protection member 15 is removed. Further, the flow path pattern member 10 is eluted from the ink ejection orifice 14, thereby forming the ink flow path 9 to produce an ink jet recording head.

The above ink jet recording head can be then cut and separated into chips by a dicing saw, and electrically joined to drive the ejection energy generating element 3. Further, a chip tank member which supplies an ink to the ink chamber can be connected.

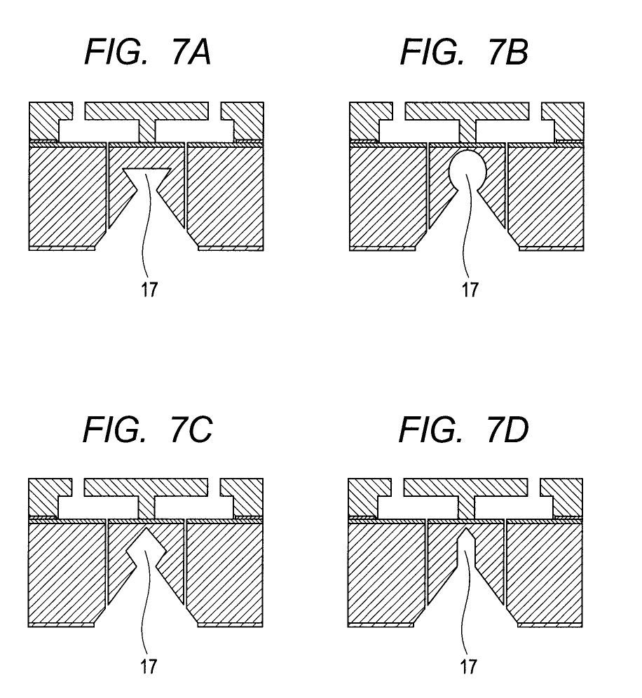

Hereinafter, representative examples of the present invention will be described. In addition to the following examples, as illustrated in, for example, FIGS. 7A to 7D, the first hollow portion 17 which continues to the ink chamber may be formed to have various shapes.

### First Example

First, as illustrated in FIG. 2A, the silicon substrate 1 which has a thickness of 625 μm and which has an ejection energy generating element 3 (material: TaSiN) is prepared. On the silicon substrate 1, a plurality of drivers or logic circuits (not illustrated) are arranged, and a heat-accumulating layer (not illustrated) and etching stop layer (SiN) 4 are formed at the flow path forming site above the drivers and logic circuits. Further, the heat-accumulating layer and etching stop layer (SiN) 4 at portions corresponding to positions at which an ink pathway 5 is formed in a subsequent process are removed.

Next, as illustrated in FIG. 2B, an adhesion-improving layer 7 and etching mask layer 8 are formed on the front surface side and back surface side of the silicon substrate 1, respectively, using polyamide resin.

The adhesion-improving layer 7 and etching mask layer 8 are specifically formed according to the following method. First, 2 μm of polyamide resin is applied on the front surface side and back surface side of the silicon substrate 1 by spin coating, and baked and cured at 100° C./30 min and 250° C./60 min in an oven furnace. Subsequently, 5 μm of a positive resist (product name: IP5700 made by Tokyo Ohka Kogyo Co., Ltd.) is applied on the front surface side and back surface side of the silicon substrate 1 by spin coating. Subsequently, the positive resist on the front surface side is exposed by an i-line stepper. Subsequently, the polyamide resin which is developed by NMD-3 (product name) made by Tokyo Ohka Kogyo Co., Ltd. is dry-etched by the RIE method, and the resist is removed by Remover 1112A (product name) made by ROHM Co., Ltd. to form the adhesion-improving layer 7. Further, 5 μm of positive resist IP5700 (product name) is applied on the back surface side of the silicon substrate 1 by spin coating, and is collectively exposed by an ihg-line projection exposure device using a photomask. Subsequently, the polyamide resin which is developed and exposed by NMD-3 (product name) made by Tokyo Ohka Kogyo Co., Ltd. is etched by chemical dry etching. Further, the resist is removed by Remover 1112A (product name) made by ROHM Co., Ltd., thereby forming the etching mask layer 8.

Next, as illustrated in FIG. 2C, the flow path pattern member 10 is formed on the front surface side of the silicon substrate 1. The flow path pattern member 10 is first formed by applying 14 μm of positive ODUR (product name) made by Tokyo Ohka Kogyo Co., Ltd. Subsequently, the flow path pattern member 10 having a flow path pattern is formed by being exposed by the ihg-line projection exposure device using a photomask and developed using MP-5050 (product name) made by Hayashi Pure Chemical Ind., Ltd.

Next, as illustrated in FIG. 3A, on the flow path pattern member 10 and adhesion-improving layer 7, the flow path forming member 11 having the ink ejection orifice 14 is formed. The flow path forming member is first formed by applying 25 μm of negative photosensitive resin by spin coating, on the silicon substrate 1 on which the flow path pattern member 10 is formed. Further, 0.5 μm of the water repellent material 13 is applied by spin coating, on the negative photosensitive resin. Subsequently, the water repellent material 13 and negative photosensitive resin are exposed by the i-line stepper using a photomask to have a pattern having the ink ejection orifices. After exposure, the flow path forming member 11 having the ink ejection orifices 14 is formed by development using a mixed solution of 60% of xylene and 40% of methyl isobutyl ketone (MIBK) and curing in an oven furnace at 140° C./60 min.

Next, as illustrated in FIG. 3B, 40 μm of OBC (product name) made by Tokyo Ohka Kogyo Co., Ltd. is applied by spin coating such that the entire front surface and lateral surfaces of the substrate 1 are covered to form the protection member 15.

Next, as illustrated in FIG. 3C, a silicon oxide film 6 is etched using the etching mask layer 8 on the back surface side of the silicon substrate 1 as a mask, and the silicon surface from which anisotropic etching is started to form the ink chamber 16 is exposed. The silicon oxide film 6 is etched for 15 minutes using BHF-U (product name) made by DAIKIN INDUSTRIES Ltd.

Further, the silicon substrate is etched using TMAH-22 (product name, tetramethylammonium hydroxide) made by Kanto Chemical Co., Inc. which is heated to adjust the temperature to 83° C. to form an ink chamber 16. The <100> surface is exposed in the bottom portion of the ink chamber 16, and the depth from the front surface of the opening of the ink chamber to this <100> surface is 350 μm. The etching time is calculated by the following expression: (predetermined thickness (μm))/(etching rate (min)).

Next, as illustrated in FIG. 4A, pilot holes 12 are formed with a depth of 160 μm in two rows in parallel on the <100> surface which is exposed, using laser (THG: wavelength of 355 nm) in the bottom portion of the ink chamber 16. At this point of time, the width between the pilot holes 12 formed in parallel does not exceed the width of the sacrifice layer 2. In this case, the width between the pilot holes 12 is 200 μm.

Next, as illustrated in FIG. 4B, using as an anisotropic etching solution TMAH-22 (product name, tetramethylammonium hydroxide) made by Kanto Chemical Co., Inc. which is heated to adjust the temperature to 83° C., the first hollow portion 17 is formed in the bottom portion of the ink chamber 16. Anisotropic etching is performed until the sacrifice layer 2 is removed. On the sidewalls of the first hollow portion 17, a <111> surface is exposed.

Next, as illustrated in FIG. 4C, an ink pathway 5 is formed to be opened on the <111> surface of the ink chamber 16 closer to the back surface side than the opening position of the first hollow portion 17 (the bottom portion of the ink chamber). The ink pathway 5 is formed by first applying 6 μm of AZ-P4620 (product name) resist made by AZ Electronic Materials by spray coating, on the back surface including the ink chamber 16 and first hollow portion 17 of the silicon substrate 1. Subsequently, by increasing the output of laser (THG: wavelength of 355 nm), a laser hole is formed with a depth which does not reach the etching stop layer 4, on the <111> surface of the ink chamber 16 closer to the back surface side than the opening position of the first hollow portion 17. Meanwhile, the laser hole is formed with a depth of 400 μm on the <111> surface at the position of the depth of 200 μm from the back surface of the silicon substrate. Subsequently, the hole formed by laser is dry-etched from the back surface side of the silicon substrate 1 by the RIE method to penetrate to the flow path pattern member 10 to form the ink pathway 5.

Next, as illustrated in FIG. 4D, the resist on the back surface of the silicon substrate 1 is removed by Remover 1112A (product name) made by ROHM Co., Ltd. Subsequently, the etching mask layer 8 is removed by chemical dry etching from the back surface. Subsequently, OBC of the protection member 15 is removed using 100% xylene. Further, the flow path pattern member 10 is eluted from the ink ejection orifice 14 by being immersed in methyl lactate which is heated to adjust the temperature to 40° C. and subjected to an ultrasonic wave of 200 kHz/200 W to form the ink flow path 9.

Finally, the flow path forming member 11 is cured at 200° C./60 min in an oven furnace.

As described above, by providing the first hollow portion 17 in the bottom portion of the ink chamber 16, dust deposited in the first hollow portion 17 hardly floats again, so that it is possible to capture dust in the hollow portion. As in the present example, by forming the boundary between the ink chamber 16 and first hollow portion 17 in a constricted shape, it is possible to effectively produce stagnation of ink when the ink flows in the first hollow portion 17 and make it difficult for dust deposited in the first hollow portion 17 to float again.

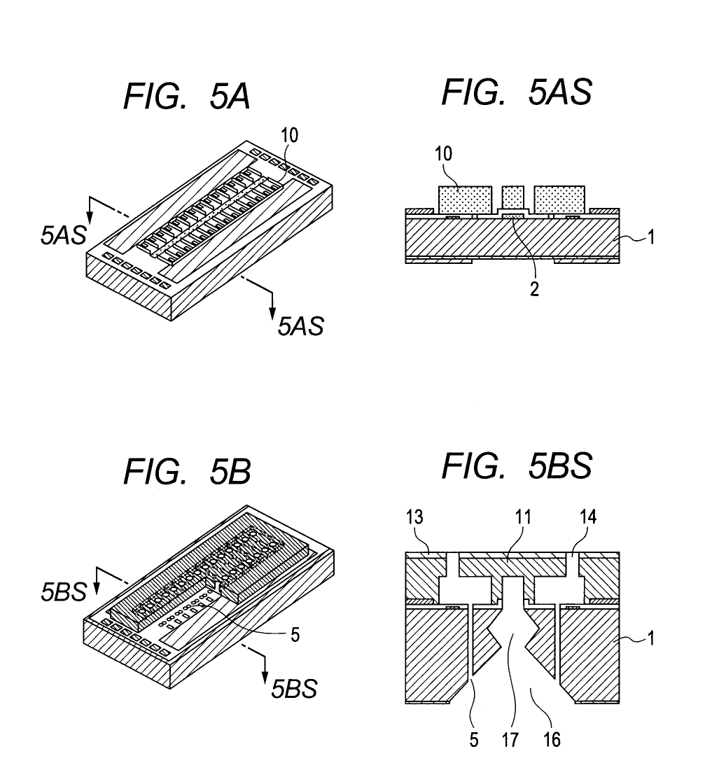

In addition to the mode illustrated in FIG. 4D, FIGS. 5BS and 7A to 7C also illustrate the mode where the constricted shape is provided. In addition, in the mode illustrated in FIGS. 7A to 7D, the bottom portion of the first hollow portion is closed inside the substrate, and the silicon forming the substrate is exposed on the entire wall surface of the first hollow portion. For example, in the case of FIG. 5B, the first hollow portion can be formed by leaving a mold material on the sacrifice layer 2 at the same time when the flow path pattern member 10 is formed. Further, in the case of FIG. 7C, the shape can be made by forming the laser pilot hole at a depth which cannot reach the sacrifice layer when the pilot holes 12 in FIG. 4A is formed.

### Second Example

In an example of the present example, a second hollow portion 18 which continues to the first hollow portion 17 may be formed in the flow path forming member 11. Hereinafter, this example will be described.

The processes of FIGS. 2A and 2B are performed in the same way as in the first example.

Next, as illustrated in FIG. 5A, 14 μm of positive ODUR (product name) made by Tokyo Ohka Kogyo Co., Ltd. which is the material of the flow path pattern member 10 is applied by spin coating on the front surface side of the silicon substrate 1. The flow path pattern member 10 having an ink flow path pattern and the pattern of the second hollow portion 18 is formed by performing exposure with an ihg-line projection exposure device using a photomask and development using MP-5050 (product name) made by Hayashi Pure Chemical Ind., Ltd., (product name). The pattern of the second hollow portion 18 can be formed on the upper side of the sacrifice layer 2.

Next, the processes from FIGS. 3A to 4C are performed in the same way as in the first example, and the first hollow portion 17 and ink pathway 5 are formed in the bottom portion of the ink chamber 16.

Next, the resist on the back surface of the silicon substrate 1 is removed by Remover 1112A (product name) made by ROHM Co., Ltd. Subsequently, the etching mask layer 8 is removed by chemical dry etching from the back surface. Subsequently, the etching stop layer (SiN) 4 exposed in the bottom portion of the first hollow portion is removed by chemical dry etching. Subsequently, OBC (product name) of the protection member 15 is removed using 100% xylene.

Next, as illustrated in FIG. 5B, the flow path pattern member 10 is eluted from the ink ejection orifice 14 and first hollow portion 17 by being immersed in methyl lactate which is heated to adjust the temperature to 40° C. and subjected to an ultrasonic wave of 200 kHz/200 W to form the ink flow path 9 and second hollow portion 18.

Finally, the flow path forming member 11 is cured at 200° C./60 min in an oven furnace.

As in the present example, by forming the second hollow portion 18 which continues to the first hollow portion 17, in the flow path forming member, it is possible to form a deeper hollow portion and deposit more dust in this hollow portion.

### Third Example

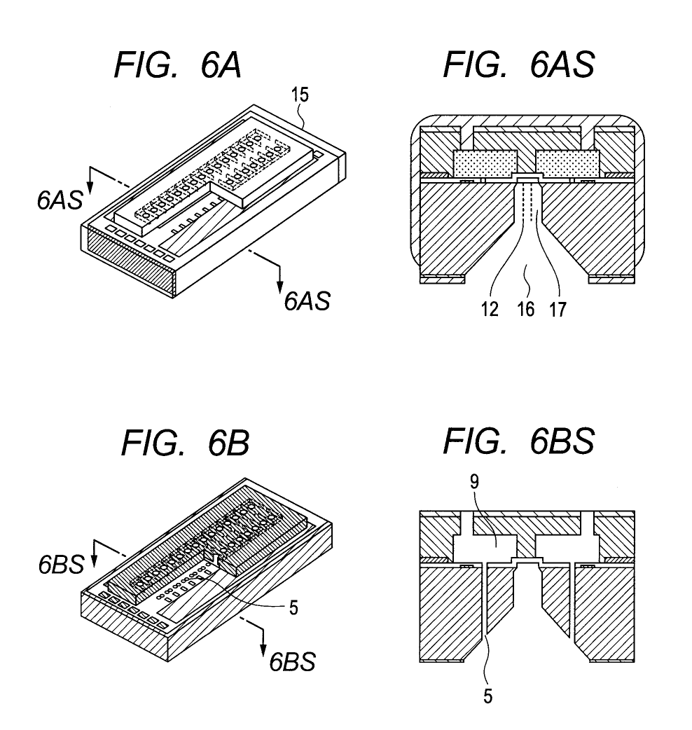

As another example of the present example, the first hollow portion 17 may be formed in a bombshell form. To form the bombshell form in FIG. 6, by forming a laser pilot hole closer to the sacrifice layer when the pilot hole 12 in FIG. 4A is formed, it is possible to remove the sacrifice layer by performing etching so as to reach the sacrifice layer in a short time. Consequently, etching can be finished before expansion in the horizontal direction progresses, so that it is possible to form the first hollow portion 17 in a columnar tapered shape, that is, in a bombshell shape.

The processes from FIGS. 2A to 3C are performed in the same way as in the first example.

Next, the pilot holes 12 are formed in two rows in parallel with a depth of 260 μm, on the <100> surface exposed in the bottom portion of the ink chamber 16 by laser (THG: wavelength of 355 nm). In this case, the width between the pilot holes 12 is 80 μm.

Next, as illustrated in FIG. 6A, using as an anisotropic etching solution TMAH-22 (product name, tetramethylammonium hydroxide) made by Kanto Chemical Co., Inc. which is heated to adjust the temperature to 83° C., the silicon substrate 1 is etched such that the sacrifice layer 2 is completely removed to form the first hollow portion 17 of the bombshell type. The first hollow portion 17 has a wall surface in the vertical direction from the end of the first slope toward the front surface side.

Further, by performing the process in FIG. 4C in the same way as the first example, the mode of FIG. 6B is formed.

The effect of the producing method according to the present example enables anisotropic etching for forming the first hollow portion 17 in a shorter time than in the first and second examples, and suppression of an increase in the number of process steps. It is possible to form the shape illustrated in FIG. 7D in a shorter time by anisotropic etching similar to the present example while suppressing an increase in the number of process steps.

As a result of conducting an ink flow test using an ink jet recording head having a hollow portion formed in the above examples, stagnation of an ink occurs in the hollow portion, thereby providing an effect of preventing dust from floating again in the ink jet recording head according to the present embodiment.

According to the configuration of the present invention, it is possible to provide a liquid ejection head which can prevent clogging of dust.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-271739, filed Dec. 6, 2010, which is hereby incorporated by reference herein in its entirety.

What is claimed is:

1. A liquid ejection head comprising:
a flow path forming member which forms an ejection orifice which is opened on a front surface and which ejects a liquid, and a liquid flow path which continues to the ejection orifice; and
a substrate comprising:
a liquid chamber which is opened on a back surface on an opposite side of the front surface and which includes a first slope which becomes narrower from a back surface side toward a front surface side;
a liquid pathway which is opened in the first slope and connects the liquid flow path and the liquid chamber; and
a first hollow portion which is provided in a bottom portion of the liquid chamber.

2. The liquid ejection head according to claim 1, wherein the first hollow portion includes a second slope which becomes wider from an end of the first slope toward the front surface side, and a third slope which becomes narrower from an end of the second slope toward the front surface side.

3. The liquid ejection head according to claim 1, wherein the first hollow portion includes a wall surface in a vertical direction from an end of the first slope toward the front surface side.

4. The liquid ejection head according to claim 1, wherein an opening of the liquid pathway in the liquid chamber has a smaller cross-sectional area than an opening of the ejection orifice on the front surface.

5. The liquid ejection head according to claim 1, wherein the second hollow portion continuing to the first hollow portion is provided inside the flow path forming member.

6. The liquid ejection head according to claim 1, wherein a bottom portion of the first hollow portion is closed in the substrate, and on an entire wall surface of the first hollow portion, a silicon forming the substrate is exposed.
